(19) United States
(12) Patent Application Publication
(10) Pub. No.: US 2006/0034550 A1
(43) Pub. Date: Feb. 16, 2006

(54) Optical recognition device and method thereof

(75) Inventor: Yaw-Hoing Wen, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: International Games System Co., Ltd.

(21) Appl. No.: 10/994,076

(22) Filed: Nov. 19, 2004

(30) Foreign Application Priority Data
Aug. 12, 2004 (TW) 93124228

(51) Int. Cl. G06K 7/10

(52) U.S. Cl. 382/321

(57) ABSTRACT

An optical recognition device for recognizing a certain type of sheets, e.g. money, includes at least one light source, at least one diverge device, at least two optical sensors, and a recognition circuit. The diverge device changes the course of light emitted from the light source into two separate lights on the sheet to be recognized. The optical sensors separately collect two response images from the sheet and the recognition device recognizes the sheet with the two response images.

### RELATED APPLICATIONS

The present application is based on, and claims priority from, Taiwan Application Serial Number 93124228, filed Aug. 12, 2004, the disclosure of which is hereby incorporated by reference herein in its entirety.

### BACKGROUND OF THE INVENTION

1. Field of Invention

The invention relates to an optical recognition device and the method thereof. In particular, the invention relates to an optical device and method for recognizing a certain type of sheets.

2. Related Art

Due to the advance of electronic techniques and the increase in human costs, more and more jobs are left to automated machines, such as various kinds of vending machines and exchange machines. At first, automated machines only accept small-value coins. They recognize the coins by their volumes, densities, and conductivities. However, as they accept higher-value currencies, it is inevitable for these machines to process such bills.

However, identifying whether a bill is true or fake is much harder than identifying a coin. Therefore, many people have proposed methods to recognize bills and there values thereof. For example, one can add a line using special magnetic ink on a bill. Then it is possible to recognize the bill through magnetism detection.

Of course, optical recognition is a most direct method. Yet it also faces the highest difficulty because most image recognition programs involve complicated algorithms. This increases the costs of the automated machines and makes them more difficult to become popular.

In fact, aside from currency bills, identifications and various kinds of valued certificates also have similar problems to be solved. Therefore, it is of great value to provide a device that can effectively recognize a certain type of sheets at a lower cost and the method thereof.

### SUMMARY OF THE INVENTION

An objective of the invention is to provide an effect and low-cost optical recognition device and the method thereof.

The invention discloses an optical recognition device for recognizing a certain type of sheets, e.g. money.

The optical recognition device includes at least a light source, a diverge device, at least two optical sensors, and a recognition circuit. Each light source has a corresponding diverge device to separate the light emitted from the light source into two separate beams toward the sheet to be recognized. The optical sensors separately collect two response images from the sheet and send them to the recognition circuit for recognition.

The diver device consists of one or more prisms. In order for the beam to project onto the sheet to be recognized and for the response images to clearly show on the optical sensors, one or more lenses may be installed on the courses of the beams for converging the beams.

The light source, the diverge device, and the lenses can be made into a module to speed up the fabrication and lower the cost.

Thus, the invention has at least the following advantages. First, the invention only needs on light source for the two optical sensors to sense two different regions. The device cost is lowered. Secondly, the light source, the diverge device, and the lenses can be made into a module. In addition, since there are not too many required devices, more optical sensors can be disposed into the limited space, increasing the scanning and sampling range of the sheet to be recognized. This is of great help in sheet recognition.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1(a) is a schematic view of an embodiment of the invention;

FIG. 1(b) is a schematic view of moving the sheet to be recognized;

FIG. 2 is a schematic view of the preferred embodiment of the invention;

FIG. 3 is an exploded view of the devices in the preferred embodiment of the invention;

FIG. 4(a) is a schematic view of some devices in the optical module;

FIG. 4(b) is a schematic view of some devices in the optical module;

FIG. 4(c) is a schematic view of some devices in the optical module;

FIG. 5 shows the operation of some devices in the optical module;

FIG. 6 shows the relation between another lens and the optical module; and

FIG. 7 is a flowchart of an embodiment of the invention.

### DETAILED DESCRIPTION OF THE PREFERRED EMBODIMENT

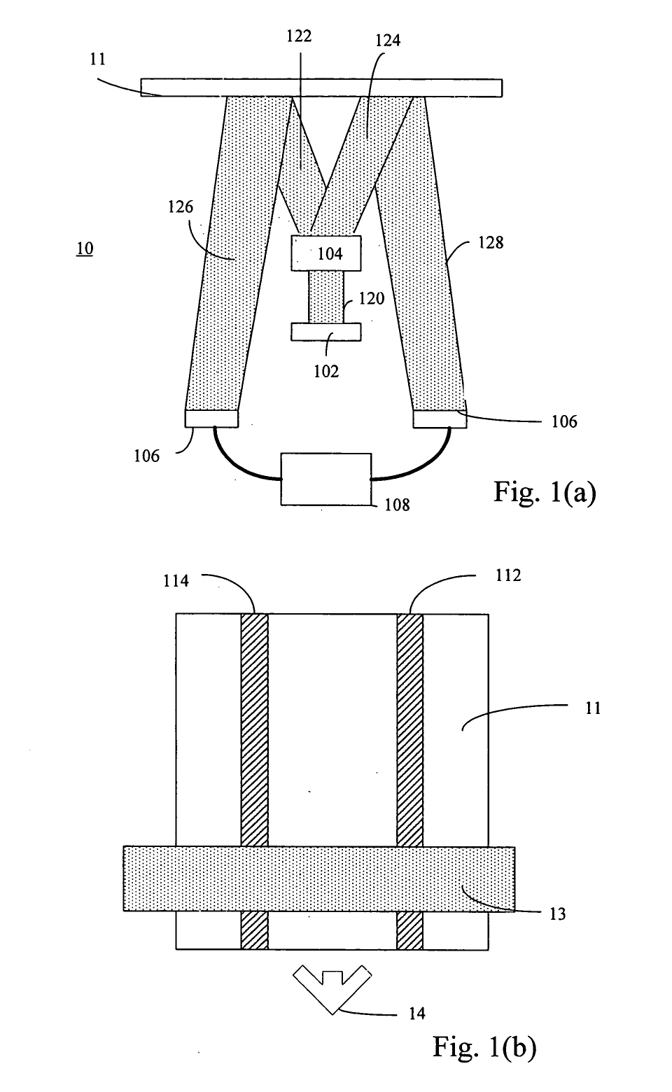

With reference to FIG. 1(a), the optical recognition device 10 is used to for recognizing a certain type of sheets 11, such as paper bills, identifications, checks, or various kinds of value certificates. The optical recognition device 10 has a light source 102, a diverge device 104 for the light source 102, two optical sensors 106, and a recognition circuit 108.

The light source 102 emits visible or invisible light 120, which is split by the diverge device 104 into two separate beams 122, 124. When a sheet of paper 11 passes through a detection area in a predetermined direction, the two beams shine on the detection area, generating two response images 126, 128. The two optical sensors 106, which may be CCD or CMOS image extraction circuits, receive respectively the response images 126, 128, and transmit the received response images 126, 128 to the recognition circuit 108 for recognition.

FIG. 1(b) shows a sheet of paper 11 passes the detection area 13 in the predetermined direction 14. Since the paper 11 continues its motion in the predetermined direction 14, the data read by the optical sensors 16 are two tracks 112, 114 on the paper 11. In other words, in this embodiment, we can read two testing tracks 112, 114 on the paper 11 using a single light source. The invention thus achieves the goal of building a simple structure with a low cost.

In the following, we use a preferred embodiment to explain how the invention is implemented.

Preferred Embodiment

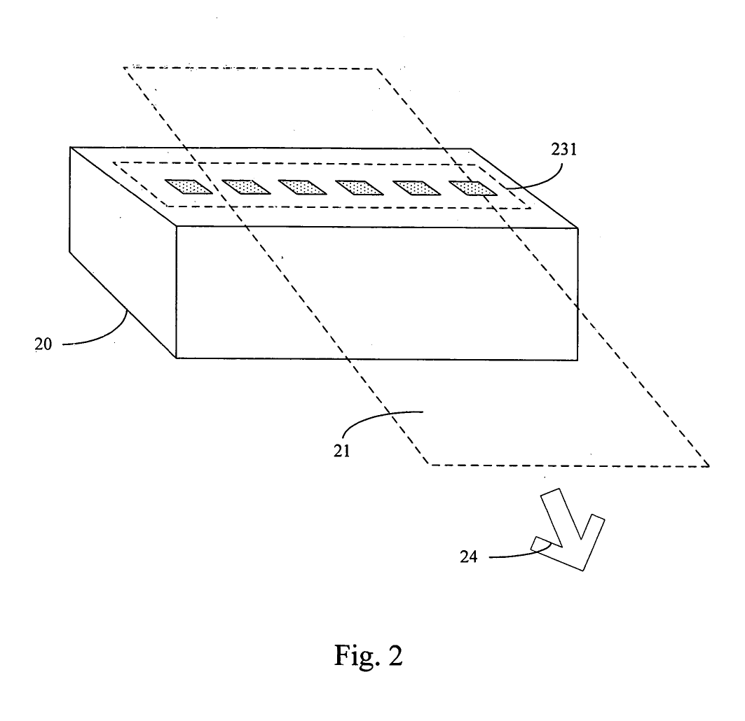

FIG. 2 gives an example of implementing the above-mentioned idea. The optical recognition device 20 can be installed in automated machines of various kinds purposes, e.g. vending machines, exchange machines, bill recognition machines. When the optical recognition device 20 is installed in an automated machine, a sheet of paper 21, e.g. money, is dragged by a mechanical device, such as a stepping motor, inside the automated machine to repeatedly or non-repeatedly move through the detection area 231 of the optical recognition device 20.

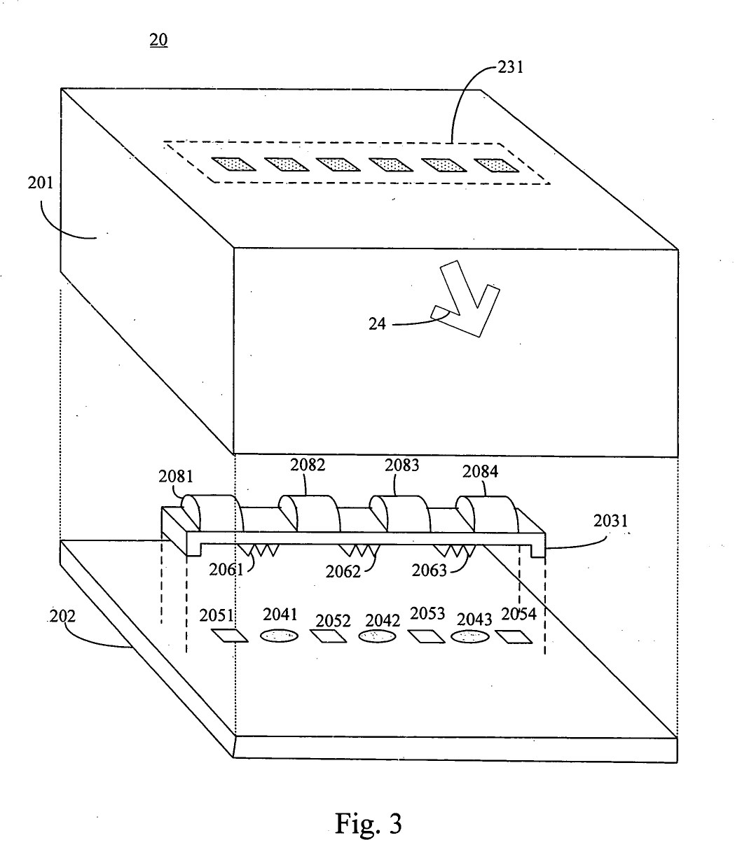

FIG. 3 is an exploded view of the optical recognition device 20. The optical recognition device 20 has an upper shell 201, a circuit board 202, an optical module 2031, light sources 2041˜2043, optical sensors 2051˜2054, and a recognition circuit and a control circuit that are not shown in the drawing.

The optical module 2031 has prisms 2061˜2063 corresponding to the light sources 2041˜2043. Moreover, the optical module 2031 is also installed with lenses 2081˜2084 corresponding to the optical sensors 2051˜2054. Using a support base, the optical module 2031 can be installed on the circuit board 202.

The optical module 2031 is comprised of several devices of the same structure. We explain the relations among them.

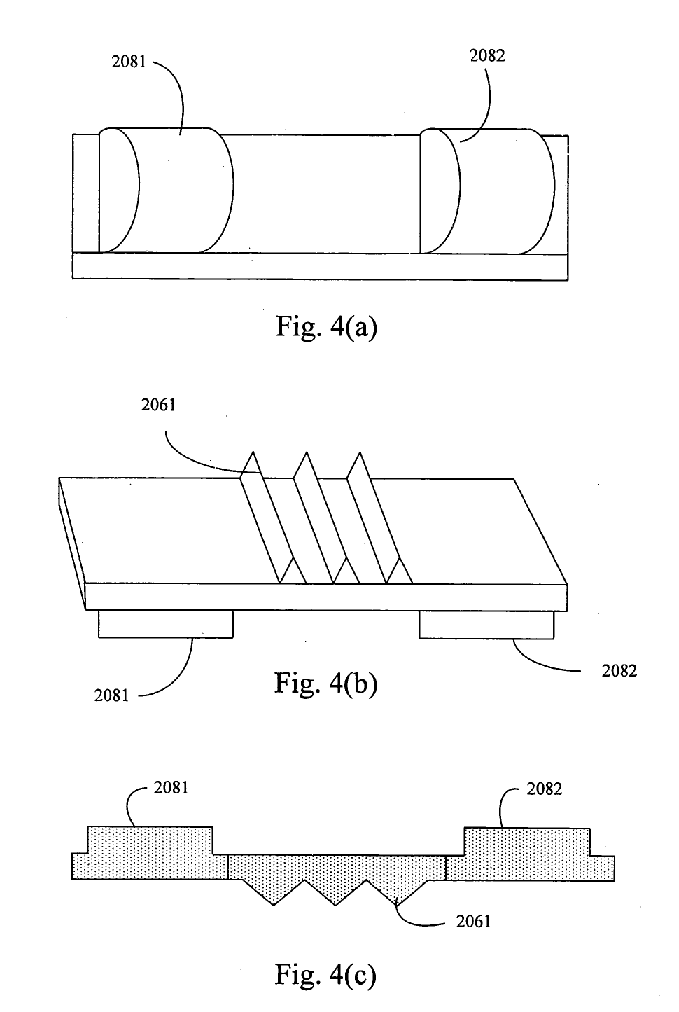

With reference to FIGS. 4(a)-(c), we see that the prism 2061 corresponds to the light source 2041. The lenses 2081, 2082 correspond respectively to the optical sensors 2051, 2052. FIG. 4(a) is a three-dimensional view of the lenses 2081, 2082 observed from a specific direction. FIG. 4(b) is a three-dimensional view of the lenses 2081, 2082 and the prism 2061 observed from a specific direction. FIG. 4(c) provides a side view. Therefore, we can see from the drawings the structures and relations among the lenses 2081, 2082, 2061. The other lenses 2083, 2084 and the prisms 2062, 2063 in the optical module 2031 have the same structures as the above-mentioned lenses 2081˜2082 and the prism 2061. One can understand the structure of the optical recognition device 20 by looking at FIG. 3. We do not repeat the description here. Moreover, the lenses mentioned herein are made of transparent plastic, formed in a single body.

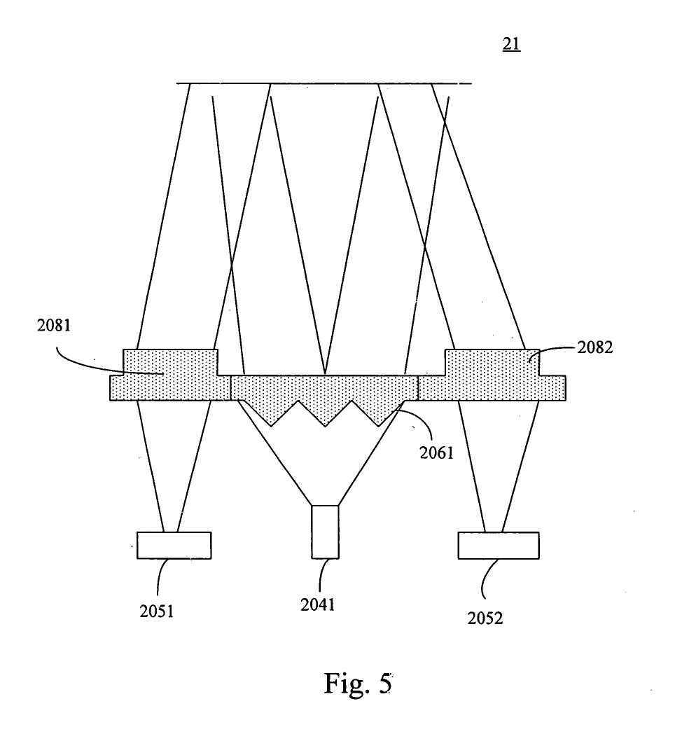

FIG. 5 shows how to use the lenses 2081, 2082 and the prism 2061 to corporate with the light source 2041 and the optical sensors 2051, 2052.

When in use, the light emitted by the light source 2041 is split by the prism 2061 into two separate beams toward the sheet of paper 21. Corresponding to the beam projection, two response images are produced and converged by the lenses 2081, 2082 onto the optical sensors 2051, 2052. The optical sensors 2051, 2052 are connected to a recognition circuit (not shown), which deciphers the information of the sheet 21 and determines whether it is true and its value.

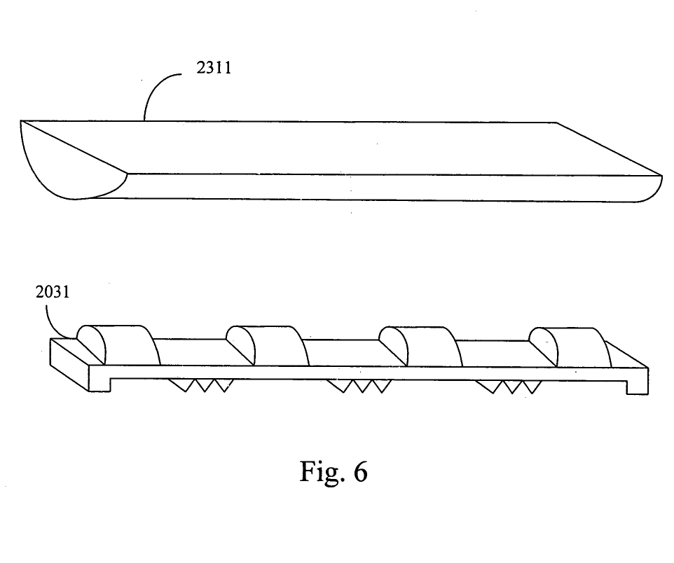

FIG. 6 shows a schematic view of adding an additional lens to the optical recognition device 20. In order for the light emitted by the light sources 2041˜2043 to converge on the sheet 21 for a better image quality, one or more lenses can be added to converge the beams. In FIG. 6, for example, a lens 2311 is added above the optical module 2031. The lens 2311 can be installed at the detection area 231 of the upper shell 201 with a surface facing the sheet 21. This provides a better converging effect on the response images.

Moreover, the lenses 2081˜2084 and the prisms 2061˜2063 are disposed in an interleaving way. In practice, each of the light sources 2041˜2043 is used simultaneously for two of the optical sensors 2051˜2054. Aside from the boundary optical sensors 2051, 2054, other optical sensors 2052, 2053 can receive the response images from the sheet 21 projected by two light sources. In this case, we use the control circuit (not shown) to control the light-emitting sequence of the light sources 2041˜2043. The recognition circuit 271 also uses the light-emitting sequence for recognition. Through many different combinations, the invention obtains the reactions of the sheet to different light sources, rendering a more accurate recognition result.

Since the sheet has different response images for different light sources, one can obtain more information about the sheet to be recognized 21 by adjusting and setting the light sources. For example, when recognizing a bill, such as a NT currency bill, experience tells us that the following light source configuration can render a fairly accurate test result. The light sources 2041, 2043 in FIG. 3 should install light emitting diodes (LED) that emit orange light. The light source 2042 is installed with an invisible light LED. The light source 2044 is installed with a red LED. Moreover, the light source 2043 is further installed with an invisible light LED. The invisible light mentioned here refers to infrared (IR) or ultraviolet (UV) light.

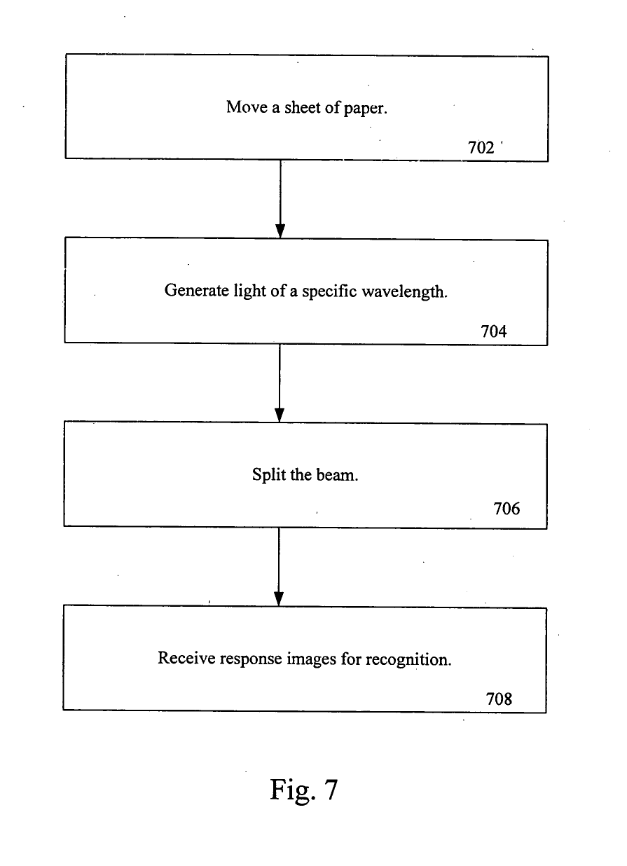

We use FIG. 7 to explain the implementation of the invention. First, the sheet to be recognized passes a detection area in a predetermined direction (step 702). A light source generates light of at least one specific wavelength (step 704). A diverge device splits the light emitted by the light source into two separate beams projected toward the sheet to be recognized (step 706). The response images generated from the beams projected onto the sheet are collected for recognition (step 708).

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An optical recognition device for recognizing a certain type of sheet passing through a detection area in a predetermined direction, the optical recognition device comprising:
at least a light source;
at least a diverge device, wherein each of the light sources corresponds to a diverge device and the diverge device splits light emitted by the corresponding light source into two separate beams to be projected onto the detection area;
at least two optical sensors installed respectively on both sides of the light source to receive two response images returned by the sheet in the detection area; and
a recognition circuit connected to at least two of the optical sensors to receive the two response images for recognition.

2. The optical recognition device of claim 1 further comprising a first lens, wherein the two separate beams first go through the first lens before reaching the detection area.

3. The optical recognition device of claim 1, wherein the diverge device includes at least a prism to split the light emitted by the light source into two separate beams.

4. The optical recognition device of claim 1 further comprising at least two second lenses, wherein each of the optical sensors has a corresponding second lens to converge the response image.

5. The optical recognition device of claim 1 further comprising a printed circuit board (PCB), which conveys the recognition circuit, the light source, and the optical sensors and contains a support base to support the at least two of the second lenses.

6. The optical recognition device of claim 4, wherein the at least two of the second lenses are made of transparent plastic in a single body.

7. The optical recognition device of claim 2 further comprising a case installed on the PCB for installing the first lens.

8. The optical recognition device of claim 1 further comprising a control circuit for controlling a light-emitting sequence of the at least one light source, wherein the recognition circuit deciphers the response images according to the light-emitting sequence.

9. The optical recognition device of claim 1, wherein the certain type of sheet is a currency bill and there are three light sources, the first light source, the second light source, and the third light source, the light sources being disposed in a row in such a way that each of the first light source and the third light source is installed with an orange light emitting diode (LED), the second light source is installed with an invisible light LED, and the third light source is installed with an invisible light LED.

10. An optical recognition method for recognizing a certain type of sheets, the method comprising the steps of:
passing the sheet through a detection area in a predetermined direction;
using at least one light source to generate light of a predetermined wavelength;
using at least one diverge device to split the light emitted by the at least one light source into two separate beams projected onto the detection area for the sheet to return at least two response images, wherein each of the at least one diverge device corresponds to one of the at least one light source;
using at least two optical sensors to receive the at least two response images; and
analyzing the at least two response images received by the at least two optical sensors for recognizing the sheet.

11. The method of claim 10 further comprising the use of a first lens for the two separate beams to be converged before reaching the detection area.

12. The method of claim 10, wherein the diverge device includes at least a prism to split the light emitted by the light source into two separate beams.

13. The method of claim 10 further comprising the use of at least two second lenses, wherein each of the optical sensors has a corresponding second lens to converge the response image.

14. The method of claim 10 further comprising the use of a printed circuit board (PCB), which conveys the recognition circuit, the light source, and the optical sensors and contains a support base to support the at least two of the second lenses.

15. The method of claim 13, wherein the at least two of the second lenses are made of transparent plastic in a single body.

16. The method of claim 13, wherein the at least two of the second lenses are made of transparent plastic in a single body.

17. The method of claim 11 further comprising the step of providing a case installed on the PCB for installing the first lens.

18. The method of claim 10 further comprising the step of providing a control circuit for controlling a light-emitting sequence of the at least one light source, wherein the recognition circuit deciphers the response images according to the light-emitting sequence.

19. The method of claim 10, wherein the certain type of sheet is a currency bill and there are three light sources, the first light source, the second light source, and the third light source, the light sources being disposed in a row in such a way that each of the first light source and the third light source is installed with an orange light emitting diode (LED), the second light source is installed with an invisible light LED, and the third light source is installed with an invisible light LED.

20. A method of recognizing a currency bill, comprising the steps of:
passing the currency bill through a detection area in a predetermined direction;
using at least three light sources to shine the currency bill in the detection area, wherein the three light sources are a first light source, a second light source, and a third light source disposed in a row, and each of the first light source and the third light source is installed with an orange LED, the second light source is installed with an invisible light LED, and the third light source is installed with an invisible light LED; and
collecting response images of the currency bill by the at least three light sources for recognition.
